(19) United States
(12) Patent Application Publication
(10) Pub. No.: US 2004/0093260 A1
(43) Pub. Date: May 13, 2004

(54) Conversion system for non-implant anchored dentures

(76) Inventor: Larry I. Hoffman, Highland Park, IL (US)

Correspondence Address: John D. Long, PO Box 3444, Reno, NV, 89059, US

(21) Appl. No.: 10/290,717

(22) Filed: Nov. 7, 2002

(51) Int. Cl. G06F 17/60

(52) U.S. Cl. 705/10

(57) ABSTRACT

A system of retrofitting non-dental implant secured dentures with dental implant technology in order to save time and expenses to the denture wearer and to provide a marketing capability that uses benefits of retrofitted dentures as communicated to dentures wearers to convince the denture wearers to receive dental implants.

The retrofitting of said dentures comprises of modifying the depression receptacle of the denture base to accept a portion of the exposed part of at least one implant affixed to the denture wearer and to accept a portion of the denture implant securing device. A portion of the denture implant securing device is affixed to the depression receptacle so as to position the dental implant securing device to be able to reversibly attach to at least a portion of the exposed part of at least one implant affixed to the denture wearer when the denture is affixed to the denture wearer.

### CROSS-REFERENCES TO RELATED PATENTS

This is a continuation-in-part application of patent application Ser. No. 09/52960 filed Mar. 15, 2000

### STATEMENT REGARDING FEDERALLY SPONSORED RESEARCH OR DEVELOPEMENT

Not Applicable

### REFERENCE TO A “MICROFICHE APPENDIX”

Not Applicable

### BACKGROUND OF THE INVENTION

A) Field of the Invention

This invention pertains in general to dental systems used to replace lost teeth due to age, accident, diseases or other impairment. In particular, the invention pertains to the conversion of a non-implant anchored denture prosthesis to be compatible with a dental implant fitted to a denture wearer. This invention also pertains to the marketing of dental implants to the denture wearer through the communication of benefits of this retrofitting system.

B) Background of the Invention

The loss of teeth can lead to speech and eating impairment with the significant tooth loss considered a social stigma in a culture which places an emphasis on, and considers to be a thing of beauty, a smile with a full set of white teeth. As result, the dental profession for centuries has worked to develop dental systems that replaces lost teeth of its patients with a prosthesis which takes up the functions (eating and aiding in talking) as well as the actual appearance of the lost teeth.

The tireless efforts of the dental profession have given rise to three well-accepted systems for tooth replacement. Two of these systems, the denture (removable prosthesis) system and the bridges (non-removable prosthesis) system, have been in use for a long time. These systems are similar in that they both utilize tooth replacement prosthesis to address only the replacement part of the missing tooth, namely the exposed portion of the tooth known as the crown.

The denture is a removable dental prosthesis which has artificial teeth imbedded in a denture base resembling a gum. The denture base provides support for the prosthesis by resting on the gingiva. The underside of the denture has a depression receptacle that receives at least a portion of the gingiva that was adjacent to the lost teeth.

The denture could either partial denture in only replacing a few teeth or it could full denture in replacing an entire set of either lower or upper teeth or both. A full denture, the surface of the depression receptacle base adheres to the appropriate gingiva of the denture wearer through saliva from the wearer's mouth causing a vacuum between the surface of the depression receptacle and the mucus membranes of the gingiva. In case of partial dentures, these dentures traditionally reversible secure to the gingiva through the use of specially designed adhesive that is applied to the gingiva and the depression receptacle for that purpose.

A bridge prosthesis is similar to that of a denture prosthesis except the bridge is normally a limited to being a partial denture which is non-reversibly cemented or otherwise affixed to the adjacent teeth.

The third and latest system for tooth loss replacement is the system of dental implants otherwise known as the field of dental implantology. This field addresses the loss of the entire tooth including the root which is the anchoring and weight bearing structure for the tooth.

Dental implantology embeds an artificial implant into the jawbone to replace or supplant the root of the patient's missing tooth. These implants can come in a wide variety of shapes, sizes, designs and compositions. The implant can have a second attachment or cap placed on its exposed portion that protrudes through the gingiva to facilitate the non-reversible fitting of the artificial crown on the top of the implant. If there is significant tooth loss, multiple implant-artificial crowns can be used to replace the lost teeth.

Sometimes to be cost effective or the patient's dental condition requires its or both, the dental profession have combined the denture system with dental implantology so to create a dentures that can be reversibly secured by a dental implant system. This system can be used to reversibly secure partial or full dentures. In this type of tooth loss replacement system, the implant is first applied to the patient. In general, the denture, especially a full denture, requires the placement of one or more dental implants into the patient to form the basis for reversibly affixing the denture to the patient.

After the implants have been properly affixed to the jawbone of the patient, a new denture is then constructed to fit in with the remaining teeth, if any. The depression receptacle of the denture is made to receive the patients gingiva, the exposed portions of the dental implant(s) and at least one securing device that allows the denture to reversibly secure to the exposed portion of the implant(s).

The type of the securing device selected depends on the type of the implant used. Commonly, the securing device can be a salient C-clip or saddle clip that straddles a post that is horizontally mounted between two post-type implants. The securing device can also be a female receptacle containing an elastomer O-ring retainer that reversibly affixes to the cap affixed to the exposed portion of the implant. The cap is male with an external grove that reversibly accommodates the O-ruing set into the female receptacle. The securing device is affixed to the denture by adhesive to the space created for it in the denture base.

In this manner, the denture can be more efficiently, reliably and securely attached to the patient than through the use of attachment systems such as the saliva-vacuum or adhesive. The use of the implant system which incorporates stand-alone anchor and weight bearing supports, has helped to alleviate a lot of the problems associated with earlier tooth replacement systems (i.e., removable dentures which caused embarrassment to the patient when they unexpectantly fell out of place, fixed bridges adding stress to adjacent teeth by relying on them for support).

However, since it is standard dental practice at present, when installing in a patent a dental implant system using dentures, to make a new denture that was specifically designed and made to be reversibly attached to the patient's dental implants. Usually this manufacture of new dentures takes two or three dental visits spread over a long period of time.

As such, the present dental implant system fails to address this situation of the denture wearer who already has dentures (the non-dental implant attached type). The current system requires the denture wearer to acquire a second set of dentures and to expend considerable cost and time to have these implant-specific dentures made.

This is especially true for denture wearers, who as they get older, either through aging process or advancement of dental disease, experience a change in their gingiva or jawbone mass. This mass loss or shape-change would prevent the gingiva from closely engaging the denture base, thus preventing the normal saliva-vacuum attachment method form being a fully effective denture securing means.

Further, a significant number of denture wearers, even with the rising prominence of the field of dental implantology, are accustom to and only understand systems and science (dentures and bridges) that have existed for a long time. These denture wearers sometimes lack the necessary understanding of dental implantology to fully appreciate the benefits that can be afforded to them by this newer system.

As a result of these current dental implant protocols, the denture wearer even when grasping the understanding of the benefits of dental implant technology must under go the additional time and significant expenses that are associated with the making and fitting of new dentures to replace their old non-implant-based dentures.

### BRIEF SUMMARY OF THE INVENTION

It is the primary object of this invention to provide a system that modifies non-implant secured dentures by retrofitting the dentures with implant technology to allow the old dentures to be able to reversibly attach to dental implants affixed to the denture wearer. It is also an objective of this system to market the dental implant technology and it benefits to denture wearers by communicating to the denture wearers that their old ill fitting dentures can be converted to an attachment system which makes their old dentures once again easily and securely attach to the denture wearer.

It is a further objective of this invention to modify the non-dental implant compatible dentures to use replaceable clips used to reversibly fasten the dentures to dental implant.

It is yet another objective of this invention to provide to wearers of non-dental implant dentures with a reversible securing mechanism for their dentures that is superior to the saliva-vacuum grip or the adhesive securing methods that are commonly used by such denature wearers.

It is yet another object of this invention, to help reduce the possibility to wearers of non-dental implant dentures that their dentures would be accidentally dislodged under embarrassing circumstances.

It is a still another objective of the invention to modify an originally non-dental implant secured dentures, which no longer closely or securely fit wearer due to aging or advancement of disease, to accept a securing apparatus that will improve the securing capabilities of the denture to the denture wearer.

It is yet another objective of the invention to allow the denture wearer, who is to receive dental implants, to avoid having to incur additional time and additional expense of making an additional denture that is specifically made for the dental implants.

It is yet another object of the invention to modify to originally non-dental implant type dentures to accept a reversible attachment device which is less susceptible to changes in the patient's jawbone mass or gingiva shape.

### BRIEF DESCRIPTION OF THE DRAWINGS

FIG. 1 A perspective drawing of the invention showing the underside view of a non-dental implant denture.

FIG. 2 A perspective partial cutaway drawing of the invention showing how an implant is placed into the bone of the jaw.

FIG. 2A A perspective view of the underside of the dentures showing an alternate embodiment of multiple implants being placed into the bone of the jaw.

FIG. 3 A perspective partial cutaway view of the invention showing the depressions created in the underside of the denture to accommodate an exposed portion of the implant.

FIG. 3A A perspective partial cutaway view of the invention which shows an alternate embodiment where the depressions created in the underside of the denture to accommodate an exposed portions of multiple implants.

FIG. 4 A prospective partial cutaway view of the invention showing the depressions created in the underside of the denture to accommodate both the securing device and the exposed portion of the implant.

FIG. 5 A perspective view of the invention showing the implant securing device secured to the denture.

FIG. 5A A perspective partial cutaway view of the denture retrofitted with dental implant technology reversibly attached to the dental implant.

### DESCRIPTION OF THE NUMERATION OF THE DRAWINGS

1 denture

2 false teeth

3 denture base

4 underside

5 depression receptacle

6 dental implant impression

7 securing device depression

10 dental implant

11 anchor

12 cap

13 securing device

14 saddle bar

15 external wing

16 main bar

17 vertical clip

18 C-clip

20 jawbone

21 bony matter

### DETAILED DESCRIPTION OF THE INVENTION

The inventor does not claim the dental implant technology or used that is used to reversibly affix dentures. The invention encompasses the modification of dentures, which were originally constructed to adhere to the denture wearer through non-implant securing methods, by retrofitting such dentures with implant technology so that said retrofitted dentures could be reversibly attached to at least one dental implant fitted to the denture wearer. The invention further includes an efficient marketing of dental implant technology to denture wearers by communicating to the denture wearers the benefits of retrofitted denture technology to their non-implant secured dentures as a means of overcoming the natural reticence of said denture wearers to newer technologies such as dental implantology.

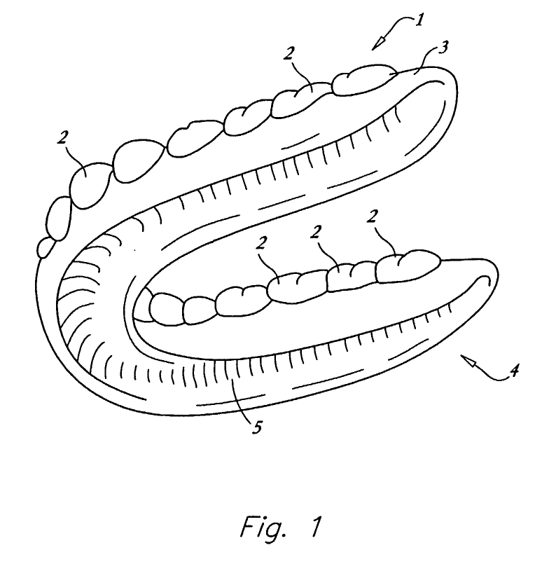

FIG. 1 shows perspective view of a full plate denture 1 that is of the type typically worn by denture wearers who are not fitted with dental implants which are used to reversibly attach dentures to the denture wearer. The said denture 1 is usually secured to the denture wearer through special adhesive, saliva-vacuum attachment or other non-dental implant securing means. Dentures which can be retrofitted with dental implant technology can be a full denture (both upper and lower or both) or a partial denture. For the purposes of this disclosure, a lower full denture will be shown as being retrofitted with dental implant technology. It should be understood that the retrofitting technology as set forth can be applied, using minor changes or modifications easily accomplished by those versed in the art, to a wide variety of denture types, including but not limited to, upper, lower and partial dentures.

The denture, generally denoted as numeral 1, comprises of a false teeth 2 embedded in the denture base 3. The false teeth 2 and denture base 3 are colored and contoured to give the appearance of real teeth and gingiva. The underside 4 or the non-crown side of the denture base 3 has a depression receptacle 5 which was molded or otherwise fitted to match and receive the contours of the wearer's gingiva that use to surround the missing teeth. An alternative embodiment of the invention also provides for the retrofitting of a partial denture with implant technology to allow the retrofitted partial denture to be reversibly attached to the denture wearer by a dental implant apparatus.

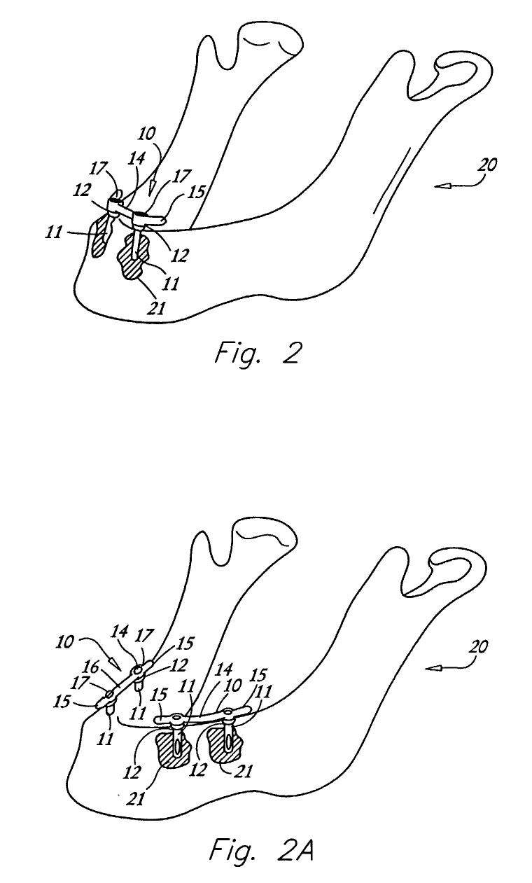

As shown in FIG. 2, at least one dental implant, generally denoted by numeral 10, using standard dental techniques well known to those versed in the art, is affixed to the denture wearer. The implant 10 is affixed to the denture wearer's jawbone 20 for reversibly securing lower (full or partial) dentures, or to both the jawbone 20 and the palate if a full set of upper and lower dentures are being retrofitted. The dental implant 10 affixed to the denture wearer to secure the retrofitted denture can be selected form a variety of different dental implant systems, all of which are well known to those versed in the art and are selected on the basis of the dental professional's preference, economy, patent condition and other factors.

There are at least three basic types of dental implant systems that can be used: the cylinder-post implant system, the blade implant system & the subperiosteal implant system. The selection of which system to use on a denture wearer whose denture is being retrofitted depends on the denture wearer's condition, dental professional's preference, expense and other factors. For example, considerations of the denture wearer's condition can include the fact that cylinder-post implant system and the blade implant systems can only be used with denture wearers who have adequate bone (jawbone/palate) height and thickness to adequately support the implant 10; the subperiosteal implant is used whenever the denture wearer's bone (jawbone/palate) structure has lost significant bone mass which can occur due to age, dental disease or wearing of dentures.

The three systems (cylinder-post, blade and subperiosteal) differ in the type of anchoring device that is applied to the dental wearer's jaw. The cylinder-post type of implant uses a generally pillar-shaped anchor that is embedded in a vertical position in the denture wearer's bone (jawbone/palate) while the subperiosteal implant places a latticework anchor attached over the denture wearer's bone (jawbone/palate).

All three implant systems comprise of an anchor 11, a cap 12 and a securing device generally denoted as 13. The securing device 13 is attached to the denture 1 to reversibly attach the denture to the implant device 10. The anchor 11 is the artificial implant that acts as and supplants the missing tooth's root.

In the preferred embodiment for retrofitting of a full denture, at least two anchors 11 of the cylinder-post type are surgically embedded in the denture wearer for the securement of one full denture. The anchors are placed at the anterior portion of the denture wearer's jawbone 20 (for securing a lower denture) or the palate (for securing an upper denture). Two sets of anchors are used for securing a set of upper and lower full dentures in both the jawbone 20 and palate, one set for each denture. The set of anchors is placed so that each anchor 11 is apart from one another.

After the anchors 11 are surgically affixed to the denture wearer's bone (jawbone 20/palate), the bony matter 21 is given time to solidly attach to the base of the anchors 11. After that attachment has occurred, caps 12 are placed on the exposed ends of the anchors 11.

In an alternative embodiment, the caps 12 themselves, which directly interface with and attaches to the securing device 13, are attached to the denture. The cap 12 forms the male portion of the male-female O-ring attachment device which is received into the interior of a matching female portion of the male-female O-ring which is retrofitted into the denture 1. In such cases, where a full denture is being used, a series (usually a set of four implants) of these implants are placed at the anterior portion of the denture wearer's bone (jawbone 20/palate) for reversibly connecting the retrofitted denture to the denture wearer.

In the preferred embodiment of the invention, a saddle bar, generally denoted as 14, which is a generally horizontal post attached to the caps 12 affixed to the anchors 11. The saddle bar 14 straddles the exposed portions of at least two anchors 11. The saddle bar 14 of the preferred embodiment is comprised of three sections: two external wings 15 and a main bar 16. An external wing 15, located at each end of the main bar 16, is gently angled to follow the curvature of the jaw line (jawbone 20/palate) while still generally maintaining the horizontally axial relationship with the main bar 16. The connection of each external wing 15 with the main bar 16 forms a vertical aperture 17 located between that external wing 15 and the main bar 16. These apertures 17 are sized and located to accept caps 12 attached to the anchors 11. The appropriate technique, well known to the practitioner of the art, is then used to secure to secure the saddle bar 14 to the caps 12 giving the exposed portion of the implant 10 a “hitching post” appearance.

As shown in FIG. 2A, an alternate embodiment of the invention for the full denture uses two separate saddle bar implants anteriorly placed in mirror positions on the anterior portion of the denture wearer's jaw (jawbone 20/palate) for securing a retrofitted lower denture. As stated above, similarly placed implants located on the palate would be used for the securing of a retrofitted upper denture.

After the completing the affixation of the dental implants 10 to the denture wearer, standard denture construction techniques, well known to those versed in the art, are employed to modify the denture wearer's non-implant secured denture 1 to accept and be secured by the denture wearer's implant.

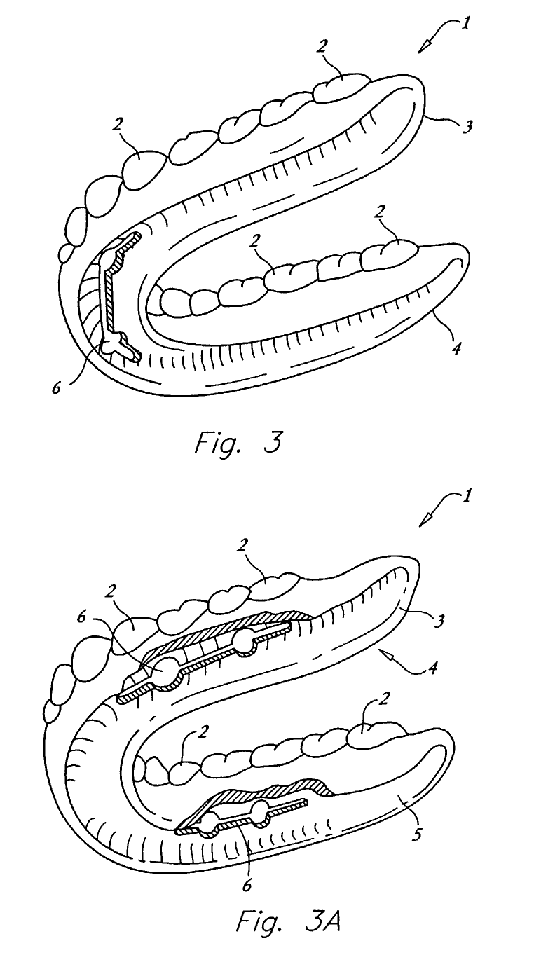

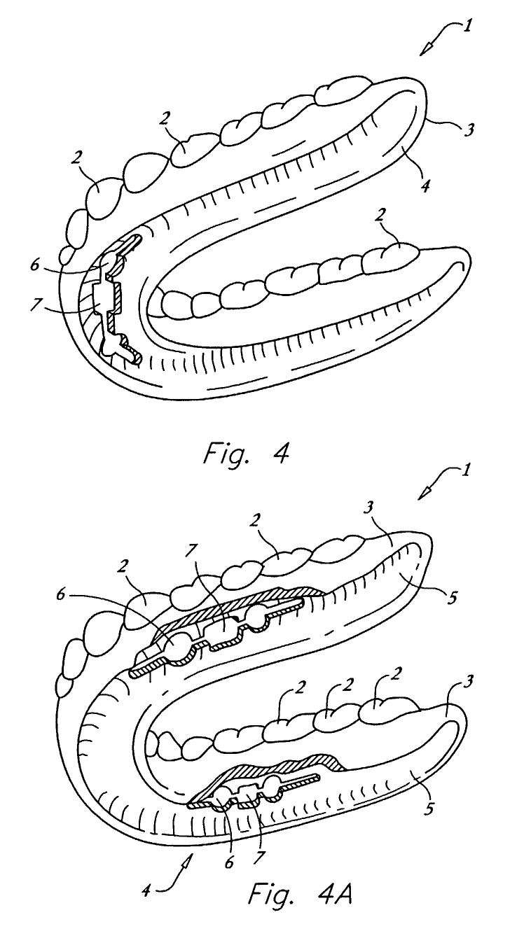

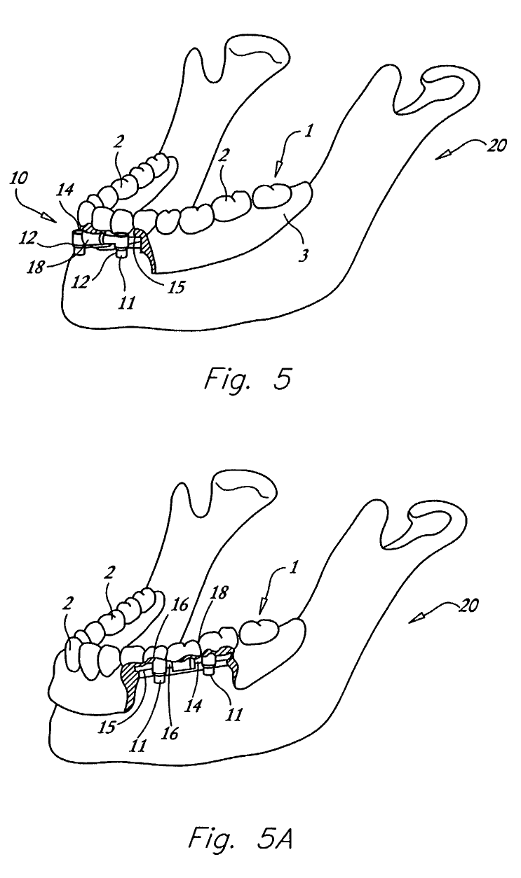

The retrofitting of the non-implant secured denture 1 with implant technology is generally shown FIGS. 3, 3A, 4 and 4A. The respective alternative embodiments of the invention accordingly also use techniques well known to those versed in the art. The first retrofitting step is the removal of an amount of dental base material from the depression receptacle 5 of the denture base 3 to create the dental implant depression 6 so as to allow the denture 1 to accept the protrusion of the exposed portion of the dental implant 10 including, but not limited to, the saddle bar 14 and caps 12. Sufficient material is removed so that the exposed portion of the dental implants 10 can be snugly, but not tightly, accepted by the dental implant impression 6.

Additional denture base material is removed from the dental implant depression 6 of the denture base 3 to create the securing device depression 7 for the receiving and attaching of the securing device 13 to the denture 1. Each implant 10 that is affixed to the denture wearer has at least one respective securing device 13 affixed to the denture 1. For dental implants 10 using a saddle bar 14, the securing device 13 that is often used is a C-clip 18. The C-clip 18 is made from resilient material such as an appropriate plastic of metal; has a C-shaped cross section; and has its length dependent upon the particular needs of the implant application. The alternate embodiment of the securing devices 13 can include the use of the male-female O-ring attachment device.

The respective portions of the securing device 13 are attached to securing device depression 7 using dental acrylic adhesive. The use of acrylic adhesive allows the attachment of the securing device 13 to be semi-permanent so that worn-out securing devices can be readily replaced.

The denture 1 is then fitted to the denture wearer with further modifications being made as required using standard dental techniques. These techniques are employed to ensure that the securing devices 13 properly reversibly engage the implant 10; that the denture 1 can properly accommodates the protrusion of the implant 10; and that the denture 1 is securely and comfortably fits the denture wearer.

Usually the retrofitting of a non-implant secured denture with implant technology saves: 1) the considerable cost of constructing a new denture specifically made for the attachment to implant(s) affixed to the denture wearer; 2) the time involved for the multiple office visits (usually at least two office visits are required); and 3) the dental laboratory time (takes at least one week turn around time for the lab to create the new denture). After being fitted with the implant, all is need is a short office visit to retrofit the old dentures to accommodate implant technology, and the patient is on her or her way with money still in their pocket.

The communication to the wearer of non-implant secured dentures of the basic benefits of having their dentures retrofitted to implant technology (snap-on and off attachment of their dentures, greater security in attachment, better fit and great savings of time and money) can be used to overcome the natural reticence of the older population of denture wearers to the new (to them) dental implant technology and embrace the technology as being able to confer benefits and savings upon them. In the preferred embodiment of the invention, the communication of benefits and savings would be disseminated to the population of wearers of non-implant secured dentures through mass media advertisement. The mass media that would b used would include, but not be limited to, wireless communication streams, print, direct mail solicitation phone solicitation and Internet communication streams.

In the preferred embodiment, the dissemination would compromise of the information that would include, bringing to the attention of the wearer of non-implant secured dentures the realization that they might have problems with their dentures. These dentures would pertain to the securing the denture to the denture wearer when using traditional non-dental implant methods such as adhesive and the like. Examples could be dramatically convened to the denture wearers of situations where dentures failed to remain secured to the denture wearer in public and embarrassing situations. The examples could also include scenarios where the denture used to fit the denture wearer, but through the passage of time it no longer does.

After using this information to attract the attention of the denture wearer, follow-up information would then be given to the denture wearer for the new securing means that is now available to them. This follow-up information would emphasis issues such that: the new securing means now available to them would provide a superior attachment for their dentures in comparison to the older traditional attachment methods, that the attachment would be snap-on/snap-off; that the fit of the denture to the denture wearer would be better than using the older attachment methods; that dentures that no longer fit the denture wearer as well as they use to can be made once again to fit the denture wearer as surely and snugly as when the denture wear first acquired the dentures; and that the new method of attachment provides for great savings in time and money as compared to the current dental practices for denture securing methods (i.e., getting new dentures that use dental implant technology). The denture wearer would then be given contact information to obtain retrofitting services.

In the preferred embodiment, the communication of the benefits of denture retrofitted with implant technology to overcome the reticence of the target audience would include the marketing of retrofitting services that used the service and trademarks to identify the invention with the source providing the invention. The service marks in the preferred embodiment would include “CLIP TIGHT FEEL RIGHT” and “CLIP TIGHT FIT RIGHT” to identify the service for retrofitting the dentures with dental implant technology. The trademark used to identify the retrofitted dentures would be “CLIP-TIGHT DENTURES”.

The foregoing is considered illustrative of the principles and general intent of the invention. As numerous alterations, modifications and changes will easily occurred embodiments described above are only one method of accomplishing the invention and are not see to limit the other embodiments as set forth in the claims language below.

I claim:

1) A method of marketing the application of implant technology non-implant secured dentures comprising of the step(s) of:
A) Communicating of at least one benefit of having a denture that is retrofitted with implant technology so it can be secured by dental implant.

2) A method of marketing as set forth in claim 1 wherein the benefits of a denture that is retrofitted with implant technology includes the savings of time.

3) A method of marketing as set forth in claim 1 wherein the benefits of a denture that is retrofitted with implant technology includes the savings of money.

4) A method of marketing as set forth in claim 1 wherein the benefits of a denture that is retrofitted with implant technology includes the having the denture that snaps-on and snaps-off from the denture wearer.

5) A method of marketing as set forth in claim 1 wherein the benefits of a denture that is retrofitted with implant technology includes the use of a pre-existing denture.

6) A method of marketing as set forth in claim 1 wherein the benefits of a denture that is retrofitted with implant technology includes the avoiding having to have a new denture made.

7) A method of marketing as set forth in claim 1 wherein the benefits of a denture that is retrofitted with implant technology includes the having the new secure reversible fit of the pre-existence of denture to the denture wearer.

8) A method of marketing as set forth in claim 1 wherein the communication is accomplished through at least one of the following group of methods consisting of: wireless communication streams, print, direct mail solicitation, phone solicitation and Internet communication streams.

9) A method of marketing as set forth in claim 1 wherein the communication of the benefits of are accomplished through the use of the trade and service marks “CLIP TIGHT FEEL RIGHT”, “CLIP TIGHT FIT RIGHT” and “CLIP-TIGHT DENTURES”.
